(19) United States
(12) Patent Application Publication
(10) Pub. No.: US 2024/0394389 A1
(43) Pub. Date: Nov. 28, 2024

(54) DATA PRIVACY IN DRIVER MONITORING SYSTEM

(71) Applicant: Samsara Inc., San Francisco, CA (US)

(72) Inventors: Rudy Wen, Menlo Park, CA (US); Brian Westphal, Livermore, CA (US); Jevon Yeoh, San Francisco, CA (US); Miranda Huey, El Dorado Hills, CA (US); Gerrit Steinbach, Toronto (CA); Young Guo, Cupertino, CA (US); Ewelina Sieradzka, San Francisco, CA (US); Robert Bales, London (GB); Alexander Stevenson, Austin, TX (US)

(21) Appl. No.: 17/811,046

(22) Filed: Jul. 6, 2022

Related U.S. Application Data
(60) Provisional application No. 63/366,515, filed on Jun. 16, 2022.

(51) Int. Cl. G06F 21/62; G06F 21/32; G06V 20/40; G06V 20/62; G06V 40/16

(52) U.S. Cl. CPC G06F 21/6218; G06F 21/32; G06F 21/62; G06V 20/46; G06V 20/625; G06V 40/161

(57) ABSTRACT

A driver monitoring system includes internal and external cameras attached to a vehicle. The cameras capture video of the vehicle's driver and the area surrounding the vehicle for later review by a coach or supervisor. To ensure privacy of people who appear in video, portions of the video may be processed to blur faces, license plates, and/or other features. Furthermore, access control mechanisms exist so that only users in specific roles have access to review certain types of video.

### INCORPORATION BY REFERENCE TO ANY PRIORITY APPLICATIONS

This application claims priority to U.S. Provisional Patent Application No. 63/366,515, filed on Jun. 16, 2022 and titled “DATA PRIVACY IN DRIVER MONITORING SYSTEM”. Any and all applications, if any, for which a foreign or domestic priority claim is identified in the Application Data Sheet of the present application are hereby incorporated by reference in their entireties under 37 CFR 1.57.

### BACKGROUND

Computing devices can collect user data on a large scale for a variety of applications. For example, computing devices attached to a vehicle can collect data that can be used to monitor and train driver safety. However, such devices will routinely capture personal and highly sensitive data such as photos and videos, which may be kept indefinitely by the person or organization collecting the data.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit or digits in a reference number refer to the figure number in which that element is first introduced.

FIG. 1A is a block diagram depicting illustrative data flows and interactions between a vehicle device, a backend server, and a driver safety administration system according to some embodiments.

FIG. 1B shows an example vehicle device comprising a driver-facing camera according to some embodiments.

FIG. 1C is the front view of the example vehicle device showing the inward-facing camera.

FIG. 1D is a rear view of the example vehicle device showing an outward-facing camera (e.g., positioned to obtain images forward of the vehicle).

FIGS. 2A-2C show an example vehicle device comprising multiple inward-facing and outward-facing cameras according to some embodiments.

FIGS. 3A and 3B are flow diagrams of an example method for blurring sensitive portions of image data acquired by a vehicle device according to some embodiments.

FIG. 4 is a flowchart illustrating one embodiment of an example method for retrieving appropriate image data based on digital user permissions.

FIG. 5 depicts an example user interface displaying a video stream with sensitive portions of the video blurred, according to some embodiments.

FIG. 6 depicts an example user interface for viewing and editing access permissions for a user role according to some embodiments.

### DETAILED DESCRIPTION

Generally described, the present disclosure relates to increasing data privacy within a driver monitoring system. To mitigate privacy and confidentiality concerns, data collectors strive to prevent unauthorized access to sensitive information in private data sets. Two methods that data collectors can employ to ensure data privacy include: (1) implementing digital access restrictions to certain data; and (2) obfuscating sensitive information, such as by blurring faces or other confidential information in images. Image data acquired by a vehicle device may be processed to detect and blur (or otherwise obfuscate) sensitive portions of the image data, for example by using a trained machine learning model for object detection. Beneficially, such processing mitigates privacy concerns regarding any sensitive and/or personal data acquired by the vehicle device.

A potential problem with existing object detection and blurring methods is that they may not be able to accurately and precisely detect sensitive information. Imprecise object detection may lead to over-blurring portions of an image such that a user viewing the blurred image may not be able to properly analyze the image. For example, in a driver monitoring system, a user may not be able to properly analyze a driver's safety performance if the image data captured by the system has been over-blurred. In other cases, inaccurate object detection may lead to under-blurring of portions of an image and/or blurring the wrong portions of an image, which may cause sensitive and/or personal information in the image to be inadvertently revealed.

Some aspects of the present disclosure address the issues noted above, among others, by detecting specific objects in image data that is inherently sensitive, such as faces and vehicle license plates, and calculating a bounding box for each detected object. As used herein, the term “bounding box” refers to a quadrilateral (or other shape) that fully or partially encompasses (or “bounds”) a detected object. The bounding box may then be used to determine specific portions of an image, which contain sensitive information, to blur. For example, the bounding box of a detected face may be used to blur the portion of an image containing the detected face. As another example, the bounding box of a vehicle may be used to determine and blur the portion of an image containing a vehicle license plate.

Additional aspects of the present disclosure relate to methods of restricting access to data containing sensitive information to only those users for whom it is necessary to access such data. Such a restriction can be achieved by implementing digital access permissions controls within a driver monitoring system. In some embodiments, these access permissions can be combined with the blurring process described above, such that only certain users are authorized to access un-blurred image data, while other users may be authorized to access images with no blurring or blurring of only a limited categories of object (e.g., blurring of faces, but not license plates). Access to other subsets of data may also be controlled, such as access to video, access to driver images, access to forward or backward facing images, and access to recorded audio streams. In some embodiments, the permissions may be grouped by role, such that all users assigned to a certain role within an organization will have access to the same data.

Various aspects of the disclosure will be described with regard to certain examples and embodiments, which are intended to illustrate but not limit the disclosure. Although aspects of some embodiments described in the disclosure will focus, for the purpose of illustration, on particular examples of vehicle devices, image processing algorithms, and access configurations, the examples are illustrative only and are not intended to be limiting. In some embodiments, the techniques described herein may be applied to additional or alternative driver monitoring systems and methods. Any feature used in any embodiment described herein may be used in any combination with any other feature, without limitation.

### Terms

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

Backend Server System (also referred to herein as a “management server”, “backend,” “cloud,” or “cloud server”): one or more network-accessible servers configured to communicated with vehicle devices (e.g., via a vehicle gateway and/or communication circuitry of a dashcam). A management server is typically configured to communicate with multiple vehicle devices, such as each of a fleet of hundreds, thousands, or more vehicles. Thus, the management server may have context and perspective that individual vehicle devices do not have. For example, the management server may include data associated with a large quantity of vehicles, such as vehicles across a fleet, multiple fleets, and/or within a geographic area. Thus, the management server may perform analysis of asset data across multiple vehicles and between groups of vehicles (e.g., comparison of fleets operated by different entities). A backend server system may also include a feedback system that periodically updates event models used by vehicle devices to provide real-time detection of events, such as safety events, that may trigger in-vehicle alerts. For example, when the backend server has optimized an event model based on analysis of asset data associated with many safety events, potentially across multiple fleets of vehicles, an updated event model may be sent to the vehicle devices.

Vehicle Device: one or more electronic components positioned in or on a vehicle and configured to communicate with a backend server system. A vehicle device includes one or more sensors, such as one or more video sensors, audio sensors, accelerometers, global positioning systems (GPS), and the like, which may be housed in a single enclosure (e.g., a dashcam) or multiple enclosures. A vehicle device may include a single enclosure (e.g., a dashcam) that houses multiple sensors as well as communication circuitry configured to transmit sensor data to a backend server system. Alternatively, a vehicle device may include multiple enclosures, such as a dashcam that may be mounted on a front window of a vehicle and a separate vehicle gateway that may be positioned at a different location in the vehicle, such as under the dashboard. In this example implementation, the dashcam may be configured to acquire various sensor data, such as from one or more cameras of the dashcam, and communicate sensor data to the vehicle gateway, which includes communication circuitry configured to communicate with the backend server system. Vehicle devices may also include memory for storing software code that is usable to execute one or more event detection models, such as neural network or other artificial intelligence programming logic, that allow the vehicle device to trigger events without communication with the backend.

Vehicle Gateway (or “VG”): a device positioned in or on a vehicle, which is configured to communicate with one or more sensors in the vehicle, e.g., in a separate dashcam mounted in the vehicle, and to a backend server system. In some embodiments, a vehicle gateway can be installed within a vehicle by coupling an interface of the vehicle gateway to an on-board diagnostic (OBD) port of the vehicle. A vehicle gateway may include short-range communication circuitry, such as near field communication (“NFC”), Bluetooth (“BT”), Bluetooth Low Engergy (“BLE”), etc., for communicating with sensors in the vehicle and/or other devices that are in proximity to the vehicle (e.g., outside of the vehicle).

Sensor Data: any data obtained by the vehicle device, such as video, audio, accelerometer, global positioning systems (GPS), any information obtained via the On-Board Diagnostic (OBD) port of the vehicle, and/or any metadata associated with the vehicle device.

Image Data: any data obtained by an imaging device, such as a camera, which may include one or both of still images and video.

Features: an “interesting” part of sensor data, such as data that is extracted from and/or derived from sensor data and may provide an abstraction of the sensor data. Features may include items (and/or metadata associated with those items) such as objects within images obtained by a camera.

Feature Detection Module: a set of logic that may be applied to image data (and/or other types of sensor data) to detect certain features in the image data. A feature detection module may be, for example, an algorithm, statistical model, neural network, or machine learning model that takes as input one or more types of image data. A feature detection module may be stored in any format, such as a list of criteria, rules, thresholds, and the like, that indicate detection of a feature. Feature detection modules may be executed by a vehicle device and/or by a backend server system (e.g., in the cloud).

Data Store: any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory, etc.), and/or the like. Another example of a data store is a hosted storage environment that includes a collection of physical data storage devices that may be remotely accessible and may be rapidly provisioned as needed (commonly referred to as “cloud” storage).

Database: Any data structure (and/or combinations of multiple data structures) for storing and/or organizing data, including, but not limited to, relational databases (e.g., Oracle databases, PostgreSQL databases, etc.), non-relational databases (e.g., NoSQL databases, etc.), in-memory databases, spreadsheets, comma separated values (CSV) files, extendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. Additionally, although the present disclosure may show or describe data as being stored in combined or separate databases, in various embodiments such data may be combined and/or separated in any appropriate way into one or more databases, one or more tables of one or more databases, etc. As used herein, a data source may refer to a table in a relational database, for example.

### Example Feature Detection Module

As will be discussed further herein, a vehicle device and/or backend server system may implement certain machine learning techniques that are configured to identify features within image data, such as in images obtained by one or more of the outward-facing or inward-facing cameras of the vehicle device. The feature detection may be performed by one or more feature detection module (e.g., part of the vehicle device and/or the backend server system), which may include program code executable by one or more processors to analyze video data (e.g., a high, standard, or low resolution video stream), still image data, and/or any other image data obtained by a vehicle device. While some of the discussion herein is with reference to analysis of video data, such discussions should be interpreted to also cover analysis of other types of image data.

In some embodiments, the vehicle device can process video data locally to identify various features, such as detection of an object (e.g., a person or a vehicle), characteristics of the object, location of the object within the image files of the video, and the like. This feature data may include metadata, which can be indexed (e.g., to a corresponding video recording or video feed) to track the time ranges that each detection begins and ends in video data. Such metadata, and other optimized data, can then be processed and/or selectively transmitted to the backend server system.

In some embodiments, the feature detection module can include a machine learning component that can be used to assist in detection of objects. For example, the machine learning component can implement machine learning algorithms or artificial intelligence to generate and/or update neural networks that are executed by a processor (e.g., in the vehicle device and/or the backend server system). In some embodiments, the machine learning component can use one or more machine learning algorithms to generate one or more models or parameter functions for the detections. In some embodiments, the feature detection module may implement an ensemble model, a modular model, a multi-modal model, and/or a stateful model. For example, the feature detection module may comprise a plurality of layered and/or hierarchical models that each produce an output that is pooled together. Further, the feature detection module may comprise a thin layer of models that is independently defined and tunable. In some embodiments, video recording criteria (e.g., pre-configured video recording criteria) can be designated by a user, administrator, or automatically. For example, the video recording criteria can indicate which types of detected features to monitor, record, or process. By designating specific types of detections, resources (e.g., processing power, bandwidth, etc.) can be preserved for only the types of feature detections desired.

Some non-limiting examples of machine learning algorithms that can be used in a feature detection module can include supervised and non-supervised machine learning algorithms, including regression algorithms (e.g., Ordinary Least Squares Regression), instance-based algorithms (e.g., Learning Vector Quantization), decision tree algorithms (e.g., classification and regression trees), Bayesian algorithms (e.g., Naïve Bayes), clustering algorithms (e.g., Apriori algorithms), convolutional neural network algorithms (e.g., You Only Look Once), deep learning algorithms (e.g., Deep Boltzmann Machine), dimensionality reduction algorithms (e.g., Principal Component Analysis), ensemble algorithms (e.g., Stacked Generalization), and/or other machine learning algorithms.

These machine learning algorithms may include any type of machine learning algorithm including hierarchical clustering algorithms and cluster analysis algorithms, such as a k-means algorithm. In some cases, the performing of the machine learning algorithms may include the use of a neural network. By using machine-learning techniques, copious amounts (such as terabytes or petabytes) of received data may be analyzed without manual analysis or review by one or more people.

### Example Backend Server System and Vehicle Device

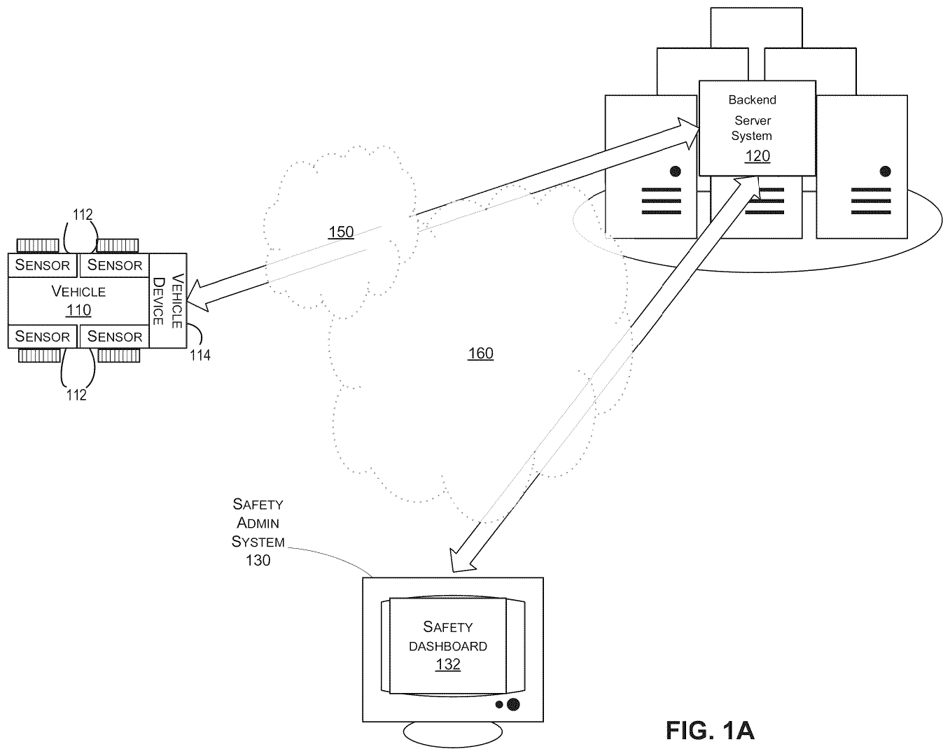

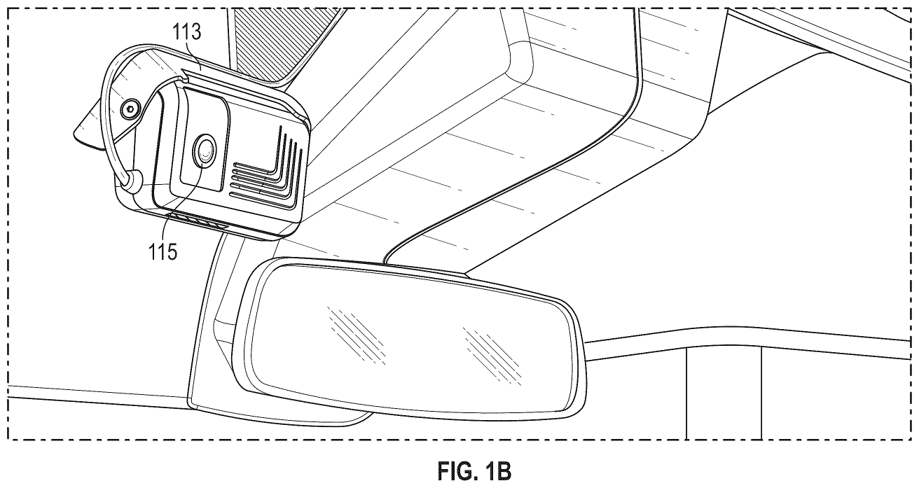

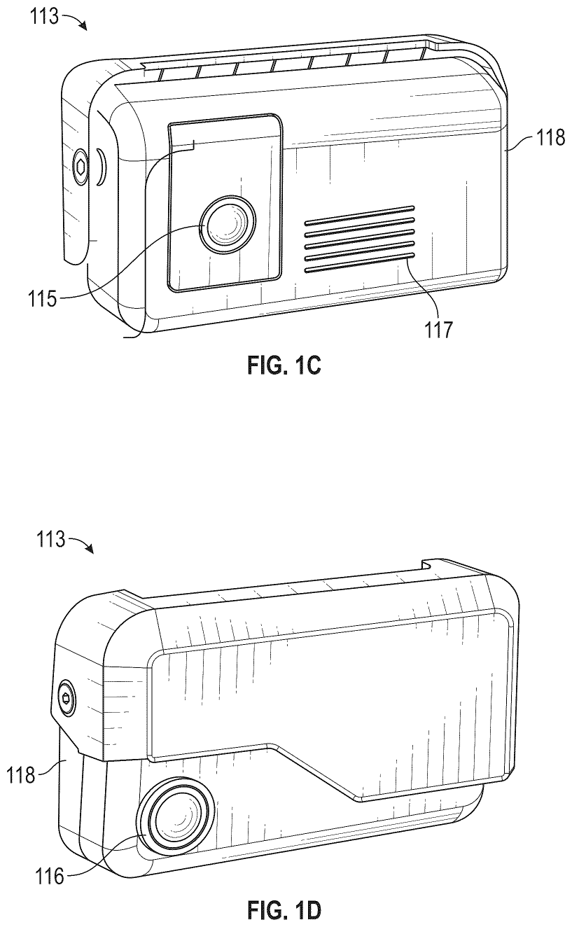

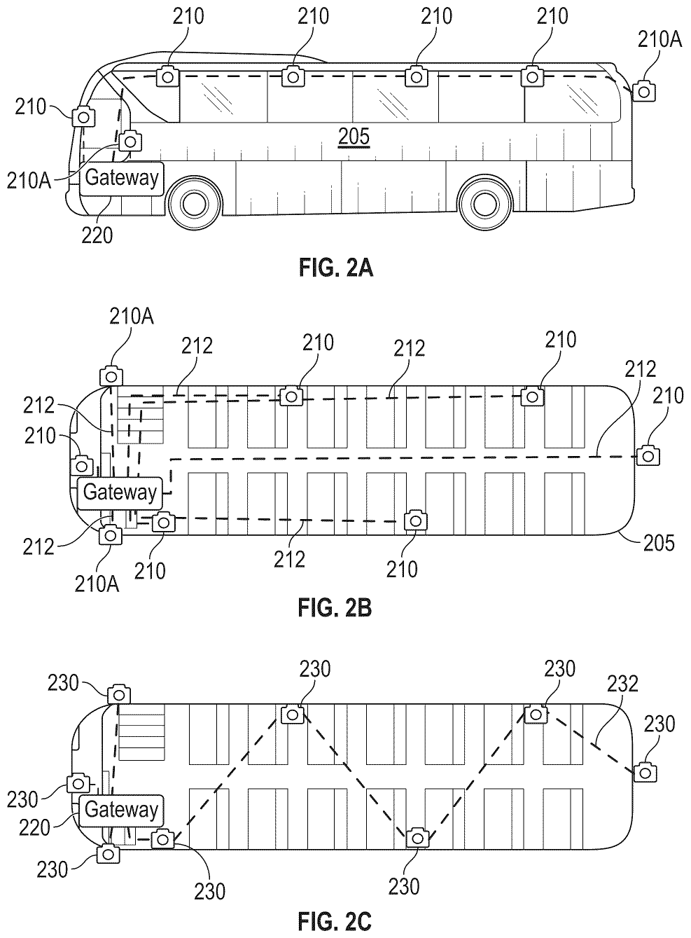

FIG. 1A illustrates a backend server system 120 in communication with a vehicle device 114 and a safety administration system 130. In this embodiment, the vehicle 110 includes a vehicle device 114, which may physically incorporate and/or be coupled to (e.g., via wired or wireless communication channel) a plurality of sensors 112. In some embodiments, the vehicle device 114 comprises a dashcam, such as the example dash cam illustrated in FIGS. 1B-1D configured to communicate with the backend server system 120. In other embodiments, the vehicle device 114 includes a dashcam and a vehicle gateway, where the dashcam is configured to communicate sensor data to the vehicle gateway and then the vehicle gateway can selectively transmit sensor data to the backend server system 120.

The sensors 112 may include, for example, one or more inward-facing camera and one or more outward-facing camera. The vehicle device 114 may, such as the vehicle gateway of the vehicle device, may include one or more microprocessors and communication circuitry configured to transmit data to the backend server system 120, such as via one or more of the networks 150, 160. In this example, a safety dashboard 132 may be generated on a safety administration system 130 to illustrate sensor data from the backend server system 120, such as via an online portal, e.g., a website or standalone application. The safety administration system 130 may be operated, for example, by a safety manager that reviews information regarding triggered safety events associated with a fleet of drivers/vehicles.

Various example computing devices 114, 120, and 130 are shown in FIG. 1A. In general, the computing devices can be any computing device such as a desktop, laptop or tablet computer, personal computer, wearable computer, server, personal digital assistant (PDA), hybrid PDA/mobile phone, mobile phone, smartphone, set top box, voice command device, digital media player, and the like. A computing device may execute an application (e.g., a browser, a standalone application, etc.) that allows a user to access interactive user interfaces, view images, analyses, or aggregated data, and/or the like as described herein. In various embodiments, users may interact with various components of the example operating environment (e.g., the safety administration system 130, the backend server system 120, etc.) via various computing devices. Such interactions may typically be accomplished via interactive graphical user interfaces or voice commands, however alternatively such interactions may be accomplished via command line, and/or other means.

As shown in the example of FIG. 1A, communications between the vehicle device 114 and backend server system 120 primarily occurs via network 150, while communication between the backend server system 120 and safety administration system 130 typically occurs via network 160. However, networks 150, 160 may include some or all of the same communication protocols, services, hardware, etc. Thus, although the discussion herein may describe communication between the vehicle device 114 and the backend server system 120 via the network 150 (e.g., via cellular data) and communication between the backend server system 120 and the safety administration system 130 via a wired and/or a wireless high-speed data communication network (including the Internet), communications of the devices are not limited in this manner.

In some embodiments, the vehicle device transmits encrypted data via SSL (e.g., 256 bit, military grade encryption) to the backend server system 120 via high-speed wireless communication technology, such as 4G LTE or 5G communications. The network 150 may include one or more wireless networks, such as a Global System for Mobile Communications (GSM) network, a Code Division Multiple Access (CDMA) network, a Long Term Evolution (LTE) network, or any other type of wireless network. The network 150 can use protocols and components for communicating via the Internet or any of the other aforementioned types of networks. For example, the protocols used by the network 150 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The network 160 may similarly include any wired network, wireless network, or combination thereof. For example, the network 160 may comprise one or more local area networks, wide area network, wireless local area network, wireless wide area network, the Internet, or any combination thereof.

FIG. 1B illustrates an example dashcam 113 of a vehicle device 114 with an inward-facing camera 115 mounted inside a vehicle. FIG. 1C is a front view of the example vehicle device 114 showing the inward-facing camera 115, and FIG. 1D is a rear view of the example vehicle device 114 showing an outward-facing camera 116 (e.g., positioned to obtain images forward or backward of the vehicle). In this example, the dashcam includes an access panel 117 configured to allow alert signals from a speaker within the enclosure 118 of the dashcam 113 to be better heard within the vehicle. In some embodiments, a microphone is positioned behind the access panel 117 also, or behind a similar additional access panel. In other embodiments, the dashcam 113 may include different quantities of video and/or still image cameras. These dual-facing cameras (e.g., the inward-facing camera 115 and one or more outward-facing cameras 116) may be configured to automatically upload and/or analyze footage using feature detection models (e.g., detecting portions of image data for blurring, safety events, and/or other features of sensor data). For example, as discussed further herein, the vehicle device 114 may advantageously apply event detection models to sensor data, including video data from one or more of the cameras, to detect safety events in real time as the events are happening. While the specifications of vehicle devices may vary greatly from one implementation to another, in one example embodiment a vehicle device may include some or all of the components below:
Outward-facing camera with a field of view of 121° or more, resolution of at least 1080p (Full HD) video, frame rate of at least 30 frames per second, HDR to optimize for bright and low-light conditions.
Inward-facing camera with a field of view of 177° or more to identify unsafe in-cab behaviors, resolution of at least 720p (HD) video, frame rate of at least 30 frames per second, infrared LED for unlit nighttime in-cab video.
Audio input and/or output device(s) configured to provide voice coaching, such as voice-based feedback and alerts in response to detection of safety events, as well as the ability to turn on audio capture (e.g., via one or more microphones) for extra context during disputes and incidents.
Recording capabilities and storage to record video footage for a rolling time period. For example, 60-100 hours or more of driving time video may be stored on the vehicle device, with an option for retrieval by the backend server system, such as to provide additional context associated with a detected safety event in a safety dashboard. Video data may be automatically uploaded to an backend server system (e.g., in the cloud) for further analysis, such as automatically uploading five seconds before to five seconds after each safety event is detected. Still images may also be captured and stored locally and/or transmitted to the backend server system. A panic button may be provided to allow the driver to manually trigger a safety event and upload video footage from one or more of the cameras. For example, the panic button may be a physical button on the vehicle device enclosure 118 and/or a virtual (or software) button that may be activated by a voice command from the driver (or a passenger in the vehicle).
Data transfer circuitry configured to automatically upload event data (e.g., metadata and asset data) to the backend server system, where the event data may be further analyzed. In some implementations, the data transfer circuitry is configured to detect availability of cellular connectivity and, when connectivity is below a threshold, delay transmission of until cellular connectivity improves.
Mounting hardware for easily mounting on the inside of a windshield, such as with heavy duty acrylic foam tape, suction cup, velcro, or the like. Tilt control to allow for proper inward-facing orientation with a wide variety of windshields.
One or more accelerometers, such as accelerometers that measure acceleration (and/or related G forces) in each of multiple axes, such as in an X, Y, and Z axis.
One or more computer processors, such as high-capacity processors that enable concurrent neural networks for real-time artificial intelligence.

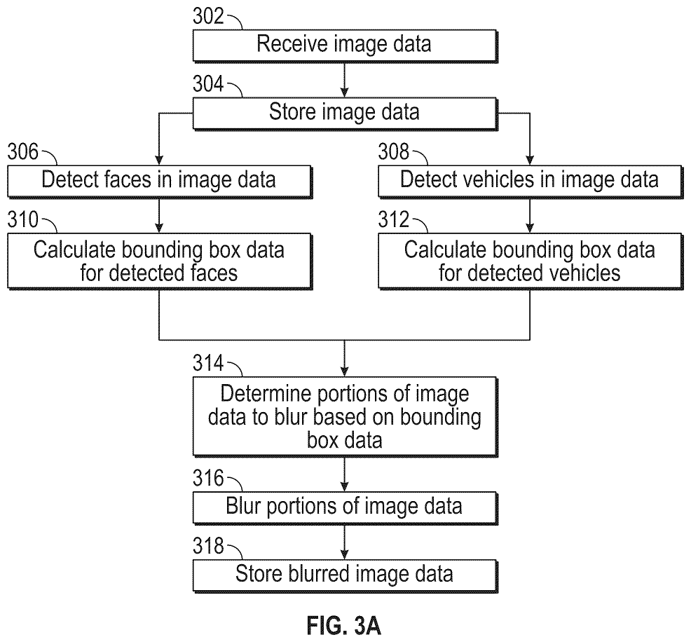

FIGS. 2A-2C illustrate example configurations of a vehicle device including multiple cameras 210 and a vehicle gateway 220. FIG. 2A is a side view and FIG. 2B is a top view of a bus 205, or other vehicle, illustrating placement of multiple camera devices (e.g., cameras, such as dash cams and/or cameras configured for mounting at other internal or external vehicle locations) 210 inside and/or outside the vehicle. In this example, cameras 210 are positioned at various locations within the vehicle, with cameras 210A position on an outer surface of the vehicle (and/or positioned to capture images outside the vehicle). As shown, each of the cameras 210 are separately connected to the vehicle gateway 220, which may comprise some or all of the functionality of the vehicle device 114 of FIG. 1A. Thus, as shown in FIG. 2B, multiple cables 212 extend across various portions of the vehicle 205 to all couple directly with the vehicle gateway 220. Depending on the vehicle, placement of such cables (e.g., electrical wiring) may involve drilling, patching, painting, etc. to place the multiple cables in various locations of the vehicle. Thus, reduction of the number of cables connecting sensor devices to the controller is desired.

FIG. 2C is another top view of the vehicle 205, now with cameras 230 in place of the cameras 210, and coupled together with cables 232 in a serial configuration that reduces wiring requirements within the vehicle. Thus, in this configuration, the complexity of wiring the cameras so that communications with the vehicle gateway 220 may occur is greatly reduced, as well as the amount of cabling needed to establish communications between the vehicle gateway 220 and each of the sensor devices 230.

### Example Feature Detection Modules and Blurring

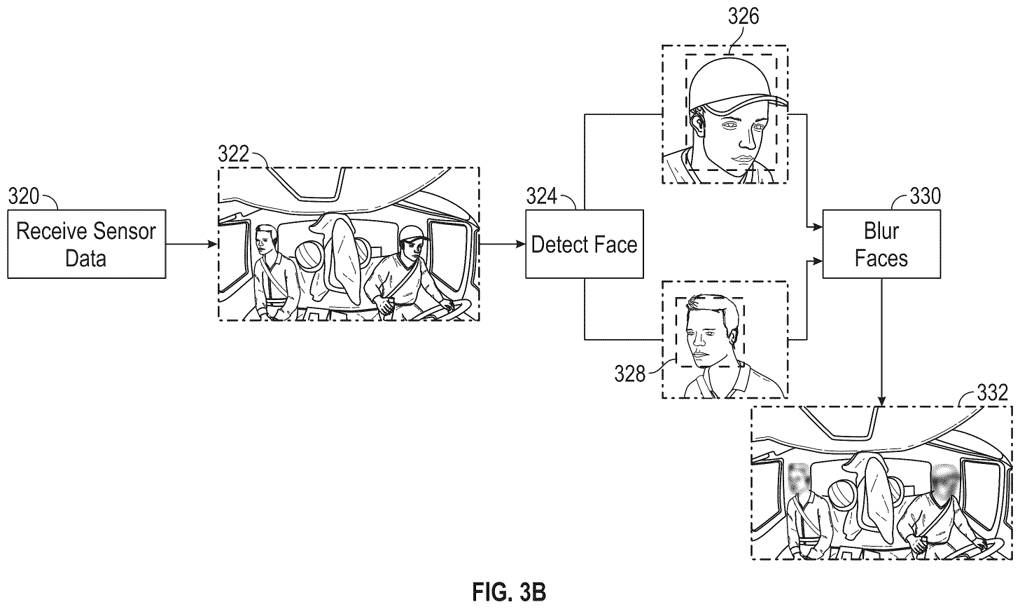

FIG. 3A is a flow diagram illustrating an example process for detecting certain features (e.g., objects which likely depict sensitive information) in image data, such as by processing video data using one or more neural networks, and blurring the portions of the image data containing those detected features. Depending on the embodiment, the method of FIG. 3A may include fewer or additional blocks and/or the blocks may be performed in an order different than is illustrated.

In general, the processes are performed by a cloud server, such as the backend server system 120 of FIG. 1A. Depending on the embodiment, however, the processes may be performed by a different device (e.g., a vehicle device) or by more than one device, the method may include fewer or additional blocks, and/or the blocks may be performed in an order different that is illustrated. As described herein, the term “processing system” refers to the device or devices that perform the illustrated processes.

For ease of illustration, the methods of FIG. 3A are discussed with reference to components of FIG. 1. However, the method may be performed by other similar components in other configurations.

In some embodiments, a blurring process, such as in the examples of FIG. 3A, may be initiated upon acquisition of image data by a vehicle device 114. The vehicle device 114 may immediately process the acquired image data in real time, either locally or by transmitting the data to a backend server system 120 for processing. In other embodiments, the image data may have been previously acquired and stored (at the vehicle device and/or the backend server system), and the blurring process is initiated only when deemed necessary or upon request (e.g., in response to a user requesting a particular piece of video data, privacy rules associated with the piece of video data may be accessed and, if blurring is included in the privacy rules, a feature detection and blurring process may be performed). In some embodiments, the blurring process may be performed at designated time intervals (e.g., nightly) for all image data acquired during the time interval (e.g., during the preceding day). In some embodiments, the blurring process may automatically be performed on certain video data based on system or user criteria, such as to automatically blur faces in video associated with a detected harsh event).

Beginning at block 302, the backend server system 120 receives image data from the vehicle device 114, where image data generally refers to still images and/or video data. For example, the vehicle device 114 may transmit image data from an outward facing camera and/or an inward facing camera to the backend server system 120. In some embodiments, the image data is transmitted in response to triggering of an event of interest by the vehicle device, such as a potential safety event (e.g., distracted driver, harsh braking, harsh turning, etc.). In other embodiments, the video data may be transmitted based on a schedule, such as a 30 second clip every 30 minutes. In some embodiments, the image data may be processed before sending to the backend server system 120. For example, a high-resolution video may be downsampled to a lower resolution video to conserve bandwidth and/or decrease transmission time in certain situations. As another example, still images may be captured from a video stream and transmitted to the backend server system 120.

At block 304, the backend server system 120 stores the received image data. The image data may be stored in one or more data stores and/or databases. In some embodiments, metadata associated with the image data may also be stored along with the image data. For example, the backend server system 120 may store metadata indicating the vehicle in or from which the image data was acquired and/or the driver of the vehicle at the time that the image data was acquired.

In some embodiments, privacy rules associated with the image data may be accessed to determine if any feature detection and blurring of the image data is needed. For example, image data associated with certain cameras (e.g., attached to particular vehicles) may not need any blurring or may need blurring of only certain features (e.g., of only license plate numbers, and not of faces within the vehicle or outside of the vehicle). The privacy rules may be system level rules that apply to all image data processed by the backend server or may be specific to a particular fleet of vehicles (e.g., same privacy rules apply to all vehicles in the fleet), particular vehicles, particular users (e.g., drivers or passengers), events, times of day, geographic locations, etc.

At blocks 306 and 308, the backend server system 120 performs feature detection on the image data to identify features that may be sensitive, such as faces or vehicle license plates. This may be achieved by executing a feature detection module, as described above. In some embodiments, the image data may be analyzed by an artificial intelligence model configured to detect these features. For example, a neural network that has been trained to detect faces and/or vehicles (or specific portions thereof, such as a license plate) may analyze the image data. In some embodiments, the artificial intelligence model is trained using image data previously acquired by one or more vehicle devices, such as images obtained from a fleet of vehicles operated by a single entity or even a larger group of vehicles operated by multiple entities. For example, the model may be trained using manually and/or automatically annotated bounding boxes over faces in image data acquired by dashcams from multiple vehicle devices (e.g., images from vehicle devices from a fleet of vehicles).

At block 306, the backend server system may evaluate image data from any cameras of the vehicle device (e.g., an inward facing camera that captures a driver and front-row passenger; any inward-facing cameras inside a multi-person vehicle, such as cameras that are position along a length of a bus; and/or any outward-facing cameras that captures a pedestrian or driver of another vehicle) to detect likely faces within the image data. Similarly, at block 308, the backend server system 120 may detect a likely vehicle or a likely certain part of a vehicle (e.g., rear of a vehicle) that is likely to include sensitive information, such as a vehicle license plate.

At blocks 310 and 312, the backend server system 120 calculates a bounding box for each detected feature object, in which the bounding box is a portion of the image data encompassing the detected feature object. In some embodiments, the bounding box is a rectangle oriented orthogonally with the target image, such as the bounding boxes illustrated in blocks 326 and 328 in FIG. 3B. In other embodiments, the bounding box may be a parallelogram or some other type of quadrilateral and/or may have a different orientation from the target image.

At block 314, the backend server system 120 determines portions of the image data to blur based at least in part on the calculated bounding boxes. For example, as shown at block 332 in FIG. 3B, the processing system may determine that the entirety of a bounding box that encompasses a person's face should be blurred. However, in some embodiments, the backend server system 120 may determine that only a portion of the bounding box should be blurred. For example, the backend server system 120 may determine that only the bottom half of a bounding box that encompasses a vehicle should be blurred, since only that portion of the bounding box is likely to contain sensitive information.

At block 316, the backend server system 120 blurs the determined portions of the image data. In some embodiments, the backend server system 120 may concurrently (or sequentially) blur all determined portions of the image data, thereby generating image data with all detected sensitive objects blurred. In other embodiments, the backend server system 120 may separately blur determined portions of the image data corresponding to a particular type of object (and/or other privacy rules), thereby generating multiple categories of blurred image data. For example, the backend server system 120 may process an un-blurred video file by: blurring portions including faces to generate a first blurred video file with all faces blurred; blurring portions showing license plates to generate a second blurred video file with all license plates blurred; and generate a third blurred video file with all sensitive portions blurred.

At block 318, the backend server system 120 stores the blurred image data generated at block 316. The blurred image data may be stored in the same data store as the image data or in a separate data store. In some embodiments, the backend server system 120 may also store metadata with the blurred image data, such as by indexing blurred image data with its corresponding image data. Other metadata that may be stored along with the image data includes metadata indicating whether the stored image data is blurred or un-blurred, whether the image data was obtained by an inward-facing or outward-facing camera, the type of image data (e.g., still image, video stream data), and the like. In some embodiments, multiple video files, associated with multiple different types of blurred objects, may be stored and separately accessible. For example, a first blurred video file with blurring of only faces, a second blurred video file with blurring of only license plates, and a third video file with blurring of both faces and license plates, may be stored as video files that may be separately accessed, such as based on the access privileges of the requesting user or system.

FIG. 3B is a flow diagram further illustrating an example process for blurring faces. For example, as shown in FIG. 3B, the example process may be used to blur the faces of a driver and passenger in image data acquired by an inward-facing imaging device mounted on a vehicle dashboard. In some embodiments, the process is performed by a backend server system 120. In other embodiments, the process may be performed by a processor within a vehicle device 114 before sending the blurred image data to a backend server system 120.

At block 320, sensor data is received. The received sensor data may have been acquired by sensors 112 on a vehicle device 114. The sensor data may comprise image data. For example, in the example of FIG. 3B, sensor data 322 comprises an example still frame image of video data acquired by an inward-facing camera mounted to a vehicle dashboard, which includes a driver and a passenger inside the vehicle. The sensor data may also comprise image data acquired by inward-facing or outward-facing imaging devices positioned at various parts of a vehicle. For example, the sensor data may comprise image data acquired by an inward-facing camera mounted in the seating area of a bus and configured to capture image data of bus passengers (as illustrated in FIGS. 2A-C). As another example, the sensor data may comprise image data acquired by an outward-facing camera, in which the image data may contain faces of pedestrians or drivers of other vehicles.

At block 324, faces are detected within the image data. As described above, the detection may be performed by an artificial intelligence model trained to detect faces in image data. In some embodiments, a bounding box is calculated for each detected face in the image data, such that the portion of the image corresponding to the detected face is encompassed by the bounding box. For example, block 326 depicts an example bounding box of the driver's face in the image data. Similarly, block 328 depicts an example bounding box of the passenger's face in the image data. As explained above, in some embodiments calculated bounding boxes may have different orientation and angles than the bounding boxes illustrated in FIG. 3B.

At block 330, the faces are blurred. In some embodiments, the entire portion of the image data corresponding to a detected face bounding box will be blurred. In some embodiments, blurring may be blurred by applying an image filter, such as a Gaussian blur filter, to the portion of the image data corresponding to a detected face bounding box. Block 332 depicts the image data from block 322 after the detection and blurring processes have been completed. As illustrated, the faces of the driver and passenger have now been blurred. The blurred image data can then be stored so that a user can later review the image data without compromising the privacy of the driver and passenger.

### Example Safety Administration System and Permissions

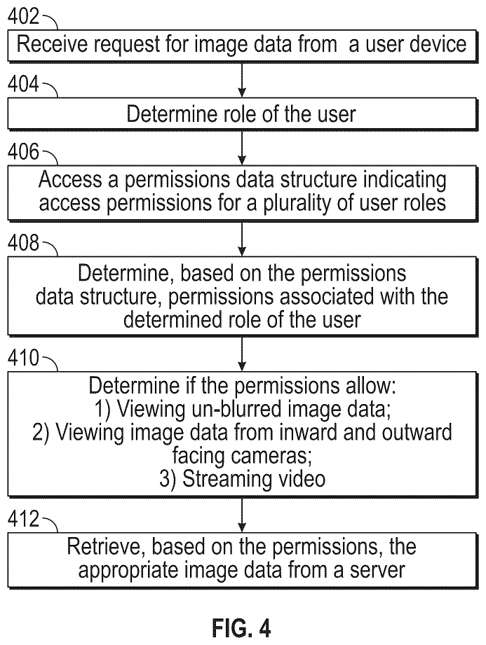

FIG. 4 is a flow diagram illustrating one embodiment of an example method for retrieving appropriate image data based on digital user permissions for the purpose of ensuring data privacy. In some embodiments, such as in the example of FIG. 4, the method may be performed by one or more computing systems that are part of the safety administration system 130 to retrieve image data from a backend server system 120. In other embodiments, the method may be performed by another type of user operating another computing system that is in communication with the backend server system 120, such as a driver of the vehicle, a supervisor of the driver and/or vehicle, and/or any other user. As used in the discussion of FIG. 4, “user device” generally refers to any computing device that attempts access to any vehicle data stored by the backend system 120, such as sensor data and/or metadata.

Beginning at block 402, a user device, e.g., the safety administration system, receives a user request for image data from associated with a driver, vehicle, and/or other criteria. For example, the request may be for a video stream from an inward-facing camera of a particular vehicle during a particular time period.

At block 404, a role of the requesting user is determined, such as by the backend server system 120 looking up an ID of the user in a user information table. In some embodiments, the user device may determine the user's role based on information received in or along with the request for image data. For example, a user device may communicate to the backend server system 120 that the image data is being requested by a driving safety coach.

At block 406, a permissions data structure indicating access permissions for a plurality of user roles is accessed. For example, the permissions data structure may be stored by the backend server system 120. In some embodiments, the permissions data structure may comprise one or more databases stored on a server. For each user role defined in the data structure, the data structure may indicate one or more access rights relating to image data, including but not limited to: enabling users to view image data acquired by inward-facing, forward-facing, and/or outward-facing cameras from vehicle devices; enabling users to access recorded audio streams accompanying acquired image data; enabling users to view overlaid image data; enabling users to view unblurred image data; enabling users to view image data containing sensitive information; and/or enabling users to mark or tag certain image data as containing sensitive information. The permissions for each user role may be defined by an organization to ensure that only users whose roles necessitate viewing sensitive image data may do so. Specific implementations of access rights for this purpose are described in greater detail below.

At block 408, the backend server system 120 determines, based on the permissions data structure, permissions associated with the determined role of the user. At block 410, the backend server system 120 determines if the permissions allow various access rights for the user, based on the user's role. For example, as illustrated in FIG. 4, the backend server system 120 may determine whether the permissions allow: (1) viewing un-blurred image data; (2) viewing image data from inward and outward facing cameras; and (3) viewing video stream data. In other embodiments, other permissions may be determined and used in determining access rights of the user to sensor data.

At block 412, the user device retrieves, based on the permissions, the appropriate image data from a server. As described above, image data may be stored in different data stores on a server based on categorization. For example, un-blurred image data may be stored in a separate data store from blurred image data. In other implementations, all image data may be stored in the same data store and indexed by metadata properties to allow retrieval of specific types of image data.

In some embodiments, the backend system provides a server endpoint (e.g., URL) pointing to a version of the requested image data that the particular user is authorized to view. In this example, the user device may request the specific image data through use of query string parameters in a uniform resource identifier (“URI”), such as a uniform resource locator (“URL”). In some embodiments, the user device retrieves the image data by sending a request to an image server specifying the requested image data and the user permissions determined at block 408, and the image server may be configured to automatically select and/or generate the image data satisfying the permissions.

### Example Safety Dashboard and Permissions Configuration

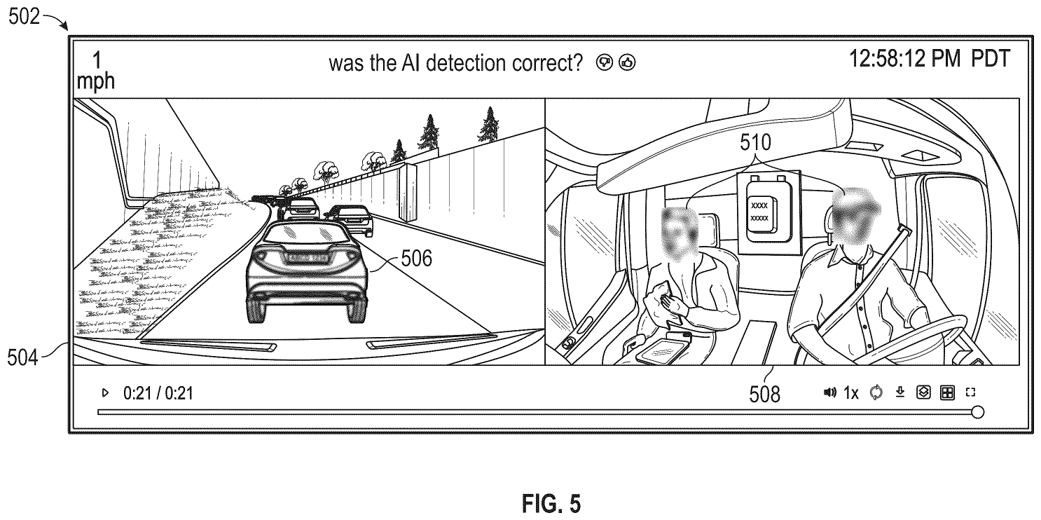

FIG. 5 depicts an example user interface 502, e.g., that may be part of the safety dashboard 132 of FIG. 1A, displaying a video stream with sensitive portions of the video blurred. The user interface 502 may be provided in response to a user (e.g., a safety officer on a safety administration system 130) navigating to a video link (e.g., provided by the backend servers system in block 412 of FIG. 4). In some embodiments, as illustrated in FIG. 5, the user interface 502 includes a video stream displaying image data 504 acquired from sensors on a vehicle device 114. The video stream may include image data from one or both of inward-facing and outward-facing cameras. In some embodiments, the video stream may include image data from multiple inward-facing or outward-facing cameras. For example, when displaying image data acquired from a vehicle device 114 coupled to a bus (as illustrated in FIGS. 2A-C), the video stream may include image data 504 acquired by a forward-facing external camera, a backwards-facing external camera, and multiple inward-facing cameras directed at various locations in the interior of the bus. The video stream may include image data associated with a particular driver and/or vehicle.

As illustrated in FIG. 5, the outward facing image data 504 may include images of a vehicle 506 (generally applicable when the image data is acquired by an outward-facing camera). In the example of FIG. 5, the lower half (or other portion in other embodiments) of the vehicle 506 is blurred so as to obfuscate a license plate number. The area of the images to which blurring is applied may include some or all of a bounding box generated by the feature detection module, e.g., indicating a rear end of a vehicle or a smaller area more specifically associated with a license plate on the vehicle. In an embodiment where the feature detection module is configured to generate a bounding box specifically to the license plate area (e.g., and not the entire back end of the vehicle), the entire bounding box area may be blurred. In other embodiments, the bounding box associated with the entire vehicle 506 may be blurred.

The inward facing image data 508 may include images of one or more faces 510 (generally applicable when the image data is acquired by an inward-facing camera). In the example of FIG. 5, the faces 510 are blurred so as to protect privacy of the individuals in the images. The area of the images to which blurring is applied may include some or all of a bounding box generated by the feature detection module, e.g., indicating all portions of a person, an upper half of a person, a head of a person, a face of the person, and/or other portion of a person. In an embodiment where the feature detection module is configured to generate a bounding box specifically to the head and/or face of individuals, the entire bounding box area may be blurred. In an embodiment where the feature detection module is configured to generate a bounding box to an upper body of individuals (e.g., from the waist area upward), only an upper portion of the bounding box may be blurred (e.g., the top half, or some other percentage, of the bounding box). In other embodiments, the entire upper body may be blurred so as to more completely obfuscate personal information of the individual.

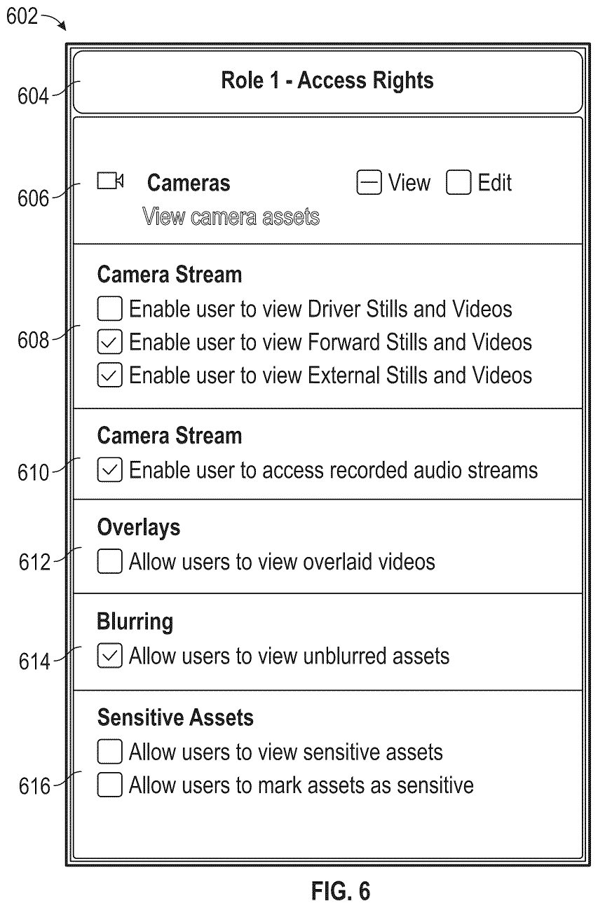

FIG. 6 depicts an example user interface for viewing and editing access permissions for a user role 604. The permission user interface may be accessible by a fleet administrator or other supervisor, for example, to set privacy constraints for all users (and/or specific groups of users) under their supervision. The user interface 602 may include various panels (606, 608, 610, 612, and 614) for editing the access rights for the role. For example, the user interface 602 may include a panel 606 for configuring whether the user role 604 can view and/or edit camera assets, such as image data acquired by a vehicle device 114.

The user interface 602 may further include a panel 608 for configuring the types of image data that the user role 604 can view. In the example implementation illustrated in FIG. 5, the user role 604 is not provided with access rights to view image data of drivers, such as image data acquired by an inward-facing camera mounted on a vehicle dashcam (as depicted in FIG. 1B). Thus, users having the particular user role (e.g., “Role 1”) may be provided with image data with blurring of driver faces. In this example, the user role 604 is provided with access to view image data acquired by a forward-facing camera or other outward-facing cameras mounted on a vehicle. In other embodiments, the access rights may be more granular, such as by separating permissions to view still images and videos.

The user interface 602 may further include a panel 610 for configuring whether the user role 604 can access recorded audio streams, which may be acquired by a vehicle device 114 along with image data. In some embodiments, a sensor on a vehicle device 114 may capture both audio and image data. The audio data may be stored and processed along with its corresponding image data, or may be stored separately from image data. In some embodiments, metadata may be stored indicating relationships between image data and audio data.

The user interface 602 may further include a panel 612 for configuring whether the user role 604 can view overlaid videos. In some embodiments, a driver monitoring system may allow for overlaying identifiers onto image data. The system may overlay identifiers, such as a bounding box, over certain features in image data detected by a feature detection module, as illustrated in FIG. 5. For example, the system may overlay bounding boxes of a cell phone being used by a driver, indicating possible distracted driving. Other indicators may also be overlaid onto image data, such as a vehicle's speed or an indication of distracted or reckless driving.

The user interface 602 may further include a panel 614 for configuring whether the user role 604 can view unblurred image data, and a panel 616 for configuring whether the user role 604 can view image data containing sensitive information and/or mark image data as containing sensitive information.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program. In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments may not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

1. A computing system comprising:
a hardware computer processor;
a non-transitory computer readable medium having software instructions stored thereon, the software instructions executable by the hardware computer processor to cause the computing system to perform operations comprising:
receiving a first video stream acquired by an imaging device positioned in a vehicle;
storing the first video stream;
determining privacy rules associated with the first video stream, the privacy rules indicating at least a first feature to obfuscate;
performing feature detection of the first video stream to identify the first feature in images of the first video stream;
generating a second video stream by applying blurring to the detected first feature in images of the first video stream;
storing the second video stream separate from the first video stream;
receiving a request from a user for at least a portion of the first video stream;
determining, based on an access rights data structure, access rights of the user to sensitive information; and
if the access rights of the user allow viewing of sensitive information, providing a first video link associated with the first video stream to the user; or
if the access rights of the user do not allow viewing of sensitive information, providing a second video link associated with the second video stream to the user.

2. The computing system of claim 1, wherein the feature detection comprises:
generating a bounding box around the detected first feature in images of the video stream, wherein the blurring is applied to a predetermined portion of the bounding box.

3. The computing system of claim 2, wherein the predetermined portion is a bottom half of the bounding box.

4. The computing system of claim 1, wherein the privacy rules further indicate a second feature to obfuscate and the operations further comprise:
performing feature detection of the first video stream to identify the second feature in images of the first video stream.

5. The computing system of claim 4, wherein the second video stream is generated by applying blurring to the detected first and second features in images of the first video stream.

6. The computing system of claim 4, wherein the operations further comprise:
generating a third video stream by applying blurring to the detected second feature;
and
storing the third video stream separate from the first and second first video stream.

7. The computing system of claim 1, wherein the first feature is a human face.

8. The computing system of claim 1, wherein the first feature is a license plate.

9. The computing system of claim 6, wherein the first feature is a human face and the second feature is a license plate, wherein the second video stream includes blurring of only human faces and the third video stream includes blurring of only license plates.

10. The computing system of claim 1, wherein the privacy rules are based on one or more of characteristics of the user or vehicle.

11. The computing system of claim 1, wherein the feature detection is performed based on one or more artificial intelligence model.

12. The computing system of claim 11, wherein the one or more artificial intelligence model is trained using image data acquired by a plurality of imaging devices coupled to a corresponding plurality of vehicles.

13. The computing system of claim 1, wherein the imaging device comprises at least one driver-facing imaging device and at least one outward-facing imaging device.

14. The computing system of claim 1, wherein the access rights of the user are based at least in part on a role of the user.

15. The computing system of claim 1, wherein the first and second video links are uniform resource locators (“URL”).

16. The computing system of claim 15, wherein the first video link comprises a first query string indicating at least that the first video link is associated with an unblurred video stream, and the second video link comprises a second query string indicating at least that the second video link is associated with a blurred video stream.

17. The computing system of claim 16, wherein the second query string further indicates whether the second video stream includes image data acquired by one or more inward-facing cameras, one or more outward-facing cameras, or both inward-facing and outward-facing cameras; and the first query string further indicates whether the first video stream includes image data acquired by one or more inward-facing cameras, one or more outward-facing cameras, or both inward-facing and outward-facing cameras.

18-19. (canceled)
